(19) United States
(12) Patent Application Publication
(10) Pub. No.: US 2008/0055783 A1
(43) Pub. Date: Mar. 6, 2008

(54) ACTUATOR LOCKING SYSTEM OF HARD DISK DRIVE AND METHOD OF LOCKING ACTUATOR USING THE SAME

(75) Inventors: Baekho HEO, Suwon-si (KR); Jungmoo Son, Gunpo-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/846,105

(22) Filed: Aug. 28, 2007

(30) Foreign Application Priority Data
Aug. 30, 2006 (KR) 2006-82847

(51) Int. Cl. G11B 5/54

(52) U.S. Cl. 360/256

(57) ABSTRACT

A hard disk drive (HDD) assembly includes an actuator arm including first and second contact protrusions extending from a rear portion thereof, a latch lever including a rotation axis at which the latch lever rotates and first and second stop portions disposed at predetermined locations on the latch lever to engage with respective ones of the first and second contact protrusions of the actuator arm, the first stop portion acting as a crash stop for the actuator arm, in which the first stop portion contacts the respective first contact protrusion to act as the crash stop with a force in a direction extending directly outward along a radial direction of the rotation axis of the latch lever such that no rotational momentum is created by the contact between the first stop portion and the first contact protrusion; and a method of parking the actuator arm.

### CROSS-REFERENCE TO RELATED APPLICATIONS

This application claims the benefit of Korean Patent Application No. 2006-82847 filed with the Korea Industrial Property Office on Aug. 30, 2006, the disclosure of which is incorporated herein by reference.

### BACKGROUND OF THE INVENTION

1. Field of the Invention

The present general inventive concept relates to an actuator locking system of a hard disk drive, and more particularly, to an apparatus and method of locking an actuator of a hard disk drive when a rotary shock is applied to the hard disk drive.

2. Description of the Related Art

FIGS. 1-3 are views illustrating a conventional hard disk drive (HDD). Referring to FIG. 1, the conventional latch system includes an actuator 10 to move a read/write head 14 for reproducing and/or recording data to a desired position on a disk (not illustrated) of the hard disk drive. The actuator 10 has a swing arm 12 to rotate around a pivot axis 11, and a suspension 13 installed on a front end portion of the swing arm 12 near the head 14 to support the head 14 and to elastically bias the head 14 toward a surface of the disk.

In addition, an inertia latch lever 20 locks the actuator 10 when the head 14 is parked on a ramp 15 provided in the hard disk drive disk drive near the front end portion of the swing arm 12. The inertia latch lever 20 includes a latch arm 21 that pivots due to inertia thereof, and a latch hook 22 provided at a leading end of the latch lever 21. A notch 23 is provided on a back end portion of the swing arm 12 near the latch lever 20 corresponding to the latch hook 22. A crash stop 24 limits a clockwise rotation of the swing arm 12, and a latch stop 25 limits a clockwise rotation of the latch arm 21.

In the above conventional inertial latch system, when a clockwise rotational shock is applied to the disk drive, the swing arm 12 and the latch arm 21 pivot/rotate in a counterclockwise direction due to inertias thereof, as indicated by the arrow illustrated in FIG. 2. Accordingly, the latch hook 22 catches the notch 23 to prevent the swing arm 12 of the actuator 10 from further pivoting in the counterclockwise direction.

On the other hand, when a counterclockwise rotational shock is applied to the disk drive, the swing arm 12 and the latch arm 21 pivot/rotate in a clockwise direction due to inertias thereof, as indicated by the arrow illustrated in FIG. 3. Accordingly, the swing arm 12 pivots in the clockwise direction and collides with the crash stop 24. Then, the swing arm 12 rebounds from the crash stop 24 and pivots in the counterclockwise direction. In addition, the latch arm 21 rotates in the clockwise direction and collides with the latch stop 25. Then, the latch arm 21 rebounds from the latch stop 25 and rotates in the counterclockwise direction. The rebounding latch hook 22 should then engage with the rebounding notch 23 to lock the actuator 10.

However, when the rebounding of the swing arm 12 does not exactly coincide with the rebounding of the latch arm 21, the notch 23 does not engage with the latch hook 22. As a result, the latch hook 22 does not engage with the notch 23 to lock the actuator 10. Thus, with the conventional single lever type inertial latch system, it is difficult to securely lock the actuator 10 when a counterclockwise rotational shock is applied to the disk drive.

FIGS. 4-6 are views illustrating another conventional hard disk drive. Referring to FIG. 4, the hard disk drive includes an actuator 10 that moves a read/write head 14 for reproducing and/or recording data from/to a desired position on a disk (not illustrated) of the hard disk drive. The actuator 10 includes a swing arm 12 that pivots around a pivot axis 11, and a suspension 13 installed on a front end portion of the swing arm 12 to elastically bias the read/write head 14 toward a surface of the disk. The actuator 10 also includes a voice coil motor (VCM) that rotates the swing arm 12. The VCM includes a coil 16 coupled to a back end portion of the swing arm 12 and a magnet 17 facing the coil 16.

The hard disk drive further includes an inertia latch lever 20 that locks the actuator 10 when the read/write head 14 is parked on a ramp 15. The inertia latch lever 20 includes a latch arm 21 that rotates around a rotation axis 29 due to an inertia thereof, a notch 23 provided on a first part of the rear end portion of the swing arm 12 of the actuator 10, and a crash stop 24 provided on a second part of the rear end portion of the swing arm 12. A latch hook 22 is provided on a leading end of the latch arm 21 and engages with the notch 23. An iron pin 26 is installed on a rear end portion of the latch arm 21 such that a magnetic force acts between the iron pin 26 and the magnet 17 to rotate the latch arm 21.

Referring to FIG. 4, when the read/write head 14 is parked on the ramp 15, the VCM causes the swing arm 12 to pivot in a clockwise direction around the pivot axis 11. Accordingly, a rear end portion of the swing arm 12 contacts the crash stop 24 of the latch arm 21, causing the latch arm 21 to pivot in a counterclockwise direction. Referring to FIG. 5, as the swing arm 12 pivots in the counterclockwise direction, the notch 23 of the swing arm 12 contacts the latch hook 22 of the latch arm 21 as the latch arm 21 pivots in the counterclockwise direction due to the contact between the rear portion of the swing arm 12 and the crash stop 24. Accordingly, the swing arm 12 stops pivoting in the counterclockwise direction and the read/write head 14 is parked on the ramp 15.

When the read/write head 14 is parked on the ramp 15 and a clockwise rotational shock is applied to the hard disk drive, the swing arm 12 and the latch arm 21 pivot/rotate in the counterclockwise direction due to inertias thereof. Accordingly, the notch 23 of the swing arm 12 is caught by the hook 22 of the latch arm 21, which prevents the swing arm 12 from further rotating in the counterclockwise direction. In contrast, when the read/write head 14 is parked on the ramp 15 and a counterclockwise rotational shock is applied to the hard disk drive, the swing arm 12 and the latch arm 21 pivot/rotate in the clockwise direction due to inertias thereof. Accordingly, the rear end portion of the swing arm 12 collides with the crash stop 24 of the latch arm 21 due to the clockwise rotation of the swing arm 12 and the latch arm 21. The swing arm 12 and the latch arm 21 rebound due to the collision therebetween, causing the swing arm 12 and the latch arm 21 to pivot/rotate in the counterclockwise direction. Accordingly, as described above, the notch 23 of the swing arm 12 should be caught by the latch hook 22 of the latch arm 21 to prevent the swing arm 12 from further rotating in the counterclockwise direction.

However, in the conventional inertia latch system illustrated in FIGS. 4-6, the swing arm 12 contacts the latch arm 21 twice when the swing arm 12 pivots in the clockwise direction to park the read/write head 14 on the ramp 19, after the counterclockwise rotational shock. During both contacts between swing arm 12 and the latch arm 21, a considerable shock is applied to the latch arm 21. Specifically, when a counterclockwise rotary shock is applied to the hard disk drive, the swing arm 12 and the latch arm 21 pivot/rotate in the clockwise direction. The swing arm 12 collides with the crash stop 24 and rebounds from the crash stop 24 to pivot in a counterclockwise direction. The collision of the swing arm 12 with the crash stop 24 causes the latch arm 21 to rotate in the counterclockwise direction. The latch hook 22 of the rebounding latch arm 21 locks the notch 23 of the rebounding swing arm 12 when a rebounding timing of the swing arm 12 matches a rebounding timing of the inertia latch lever 20 to prevent the read/write head 14 of the swing arm 12 from damaging the disk of the hard disk drive as a result of the applied shock.

However, referring to FIG. 6, when the rebounding timing of the swing arm 12 and the latch arm 21 is off or mismatched (i.e., when the rebounding timing of the swing arm 12 does not match the rebounding timing of the inertia latch lever 20), the latch hook 22 does not lock with the notch 23. As a result, the applied shock causes the read/write head 14 to damage the disk. In particular, when the crash stop 24 is impacted by the swing arm 12, the inertia latch lever 20 is rotated in the counterclockwise direction. A lower portion of the rebounding swing arm 12 (facing the latch arm 21) impacts an upper portion of the latch arm 21 (facing the swing arm 12), which rotates the latch arm 21 in the clockwise direction. This impact between the lower portion of the rebounding swing arm 12 and the upper portion of the latch arm 21 can cause the rebounding timing mismatch between the latch hook 22 of the inertia latch lever 20 and the notch 23 of the swing arm 12, which prevents a locking of the actuator 10 by the inertia latch lever 20.

Accordingly, there is a need to securely lock an actuator of a hard disk drive to prevent a read/write head of the actuator from damaging a disk of the hard disk drive when a shock is applied to the hard disk drive.

### SUMMARY OF THE INVENTION

The present general inventive concept provides an actuator locking system of a hard disk drive to lock an actuator against a shock, such as a clockwise or counterclockwise rotary force, applied to the hard disk drive, and a method using the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an HDD assembly, including an actuator arm including first and second contact protrusions extending from a rear portion thereof, and a latch lever including a rotation axis at which the latch lever rotates and first and second stop portions disposed at predetermined locations on the latch lever to engage with respective ones of the first and second contact protrusions of the actuator arm, the first stop portion acting as a crash stop for the actuator arm, in which the first stop portion contacts the respective first contact protrusion to act as the crash stop with a force in a direction extending directly outward along a radial direction of the rotation axis of the latch lever such that no rotational momentum is created by the contact between the first stop portion and the first contact protrusion.

The first and second stop portions may be hook shaped and the first and second contact protrusions may be notch shaped. After the contact between the first hook portion and the first contact protrusion, the second hook portion may contact the respective second contact protrusion with a force in a direction extending directly outward along a second radial direction of the rotation axis of the latch lever such that no rotational momentum is created by the contact between the second hook portion and the second contact protrusion.

The foregoing and/or other aspects and utilities of the present general inventive concept may also be achieved by providing a disc operating device to read and/or write to and/or from a storage disc, including an actuator including a head portion to read and/or write to and/or from the storage disc, and first and second notches extending from a rear portion of the actuator, and a latch member to lock the actuator in a park position when not reading or writing to or from the disc, the latch member including a rotation axis at which the latch member rotates, and first and second hook portions to contact respective ones of the first and second notches at corresponding first and second contact points of the latch member such that forces created at the first and second contact points are perpendicular to a normal line of a respective concentric circle with respect to the rotation axis of the latch member.

The latch member may include a first arm extending from the rotation axis and a second arm extending from the rotation axis in a direction substantially perpendicular to the first arm, the first hook portion being disposed at an end of the first arm opposite to the rotation axis and the second hook portion being disposed at an end of the second arm opposite to the rotation axis. The first hook portion may be disposed at a location to act as a crash stop for the actuator when the actuator is rotating into a park position and the second hook portion may be disposed at a location to act as a rebound stopper to stop the movement of the actuator after the actuator rebounds from the crash stop location.

The foregoing and/or other aspects and utilities of the present general inventive concept may also be achieved by providing a method of parking an actuator of a disc drive assembly, the method including rotating the actuator in a first direction towards a parking position, and creating a first contact between a first notch extending from a rear portion of the actuator and a first stopping member of a rotatable latch lever when the actuator is rotated in the first direction such that a contact force on the rotatable latch lever caused by the first contact is in a direction extending radially outward from a rotation axis of the rotatable latch lever and perpendicular to a normal line of a first circle having a center located at the rotation axis of the rotatable latch lever.

The method may further include creating a second contact between a second notch extending from the rear portion of the actuator and a second stopping member of the rotatable latch lever when the actuator is rotated in a second direction after the contact between the first notch and the first stopping member such that a second contact force on the rotatable latch lever caused by the second contact is in a direction extending radially outward from the rotation axis of the rotatable latch lever and perpendicular to a normal line of a second circle being concentric with the first circle.

The foregoing and/or other aspects and utilities of the present general inventive concept may also be achieved by providing a parking unit to park an actuator arm of a disc drive assembly, including a rotation axis on which the parking unit rotates, and at least one extension member extending away from the rotation axis and having a stopping portion which contacts a protrusion of the actuator arm to stop the actuator arm from rotating in a direction towards the park position, the stopping portion being positioned such that when the protrusion contacts the stopping portion a force is created on the at least one extension member in a direction along a length of the at least one extension member such that no rotation momentum is created on the parking unit.

The at least one extension member may include first and second extension members, and the first extension member may contact a first protrusion of the actuator arm to stop the actuator arm from rotating in a direction towards the park position and the second extension member may contact a second protrusion of the actuator arm to stop the actuator arm from rotating in a direction opposite to the direction of rotation towards the park position due to a rebound force created by the contact between the first protrusion and the first extension member such that the actuator becomes locked between the first extension member and the second extension member while the actuator arm is parked.

The foregoing and/or other aspects and utilities of the present general inventive concept may also be achieved by providing a hard disk drive assembly, including an actuator including a pivot axis around which the actuator pivots, and a read/write head to record and/or reproduce data on a disk of the hard disk drive assembly, a latch lever including a rotation axis around which the latch lever rotates, and an actuator locking system extending from a portion of the actuator and the latch lever to lock the actuator in a clockwise position in response to a counterclockwise rotary shock applied to the hard disk drive, and to lock the actuator in a counterclockwise position in response to a clockwise rotary shock applied to the hard disk drive.

The actuator locking system may include a first locking unit on one of the actuator and the latch lever to lock the actuator in the counterclockwise position, and a second locking unit on the other one of the actuator and the latch lever to lock the actuator in the clockwise position. The first locking unit may include a first contact protrusion disposed on an end of the actuator facing the latch lever and a first stop portion disposed on the latch lever to contact the first contact protrusion to lock the actuator in the counterclockwise position, and the second locking unit may include a second contact protrusion disposed on the end of the actuator facing the latch lever and a second stop portion disposed on the latch lever to contact the second contact protrusion to lock the actuator in the clockwise position.

The first and second contact protrusions may be first and second notches, and the first and second stop portions may be first and second latches. The first and second receiving stop portions may face the first and second contact protrusions, respectively. The first and second contact protrusions may extend away from each other. The first and second stop portions may face each other.

The first and second stop portions may be disposed a predetermined distance from each other on the latch lever such that a point on the latch lever where the first contact protrusion and the first stop portion contact each other is on a normal line of a first virtual circle having a center at the rotation axis of the latch lever and a point on the latch lever where the second contact protrusion and the second stop portion contact each other is on a normal line of a second virtual circle having a center at the rotation axis of the latch lever. A diameter of the first virtual circle may be greater than a diameter of the second virtual circle. When the swing arm rotates in a clockwise direction and collides with the latch lever, the second stop portion may contact the second contact protrusion to lock the actuator in the clockwise position and to prevent the collision from further rotating the latch lever in a counterclockwise direction.

The foregoing and/or other aspects and utilities of the present general inventive concept may also be achieved by providing an actuator locking system of a hard disk drive, including a first locking unit comprising a first contact protrusion disposed on an actuator of the hard disk drive and a first stop portion disposed on a latch lever of the hard disk drive to contact the first contact protrusion to lock the actuator in a counterclockwise position, and a second locking unit comprising a second contact protrusion disposed on the actuator and a second stop portion disposed on the latch lever to contact the second contact protrusion to lock the actuator in a clockwise position.

The foregoing and/or other aspects and utilities of the present general inventive concept may also be achieved by providing a latch lever of a hard disk drive, including a first stop portion to contact a first portion of an actuator of the hard disk drive to lock the actuator in a counterclockwise position, and a second stop portion to contact a second portion of the actuator to lock the actuator in a clockwise position, and the first and second stop portions may be disposed a predetermined distance from each other on the latch lever such that a point of contact on the latch lever between the first contact protrusion and the first stop portion is on a normal line of a first virtual circle having a center at a rotation axis of the latch lever, and a point of contact on the latch lever between the second contact protrusion and the second stop portion is on a normal line of a second virtual circle having a center at the rotation axis of the latch lever.

The foregoing and/or other aspects and utilities of the present general inventive concept may also be achieved by providing a method of locking an actuator of a hard disk drive, the method including rotating the actuator in a first rotation direction to contact a first contact protrusion of the actuator with a first stop portion of a latch lever to lock the actuator at a first position, and rotating the actuator in a second rotation direction opposite to the first rotation direction to contact a second contact protrusion of the actuator with a second stop portion of the latch lever to lock the actuator at a second position different from the first position.

The rotating of the actuator in the first rotation direction may include contacting the first contact protrusion with the first stop portion at a point on the latch lever that is on a normal line of a first virtual circle having a center at a rotation axis of the latch lever, and the rotating of the actuator in the second rotation direction may include contacting the second contact protrusion with the second stop portion at a point on the latch lever that is on a normal line of a second virtual circle having a center at the rotation axis of the latch lever.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1-3 are view illustrating a conventional hard disk drive;

FIGS. 4-6 are views illustrating another conventional hard disk drive.

FIG. 7 is a view illustrating a hard disk drive, according to an embodiment of the present general inventive concept.

FIG. 8 is a view illustrating an actuator of the hard disk drive of FIG. 7 locked in a clockwise position, according to an embodiment of the present general inventive concept.

FIG. 9 is a view illustrating the actuator of the hard disk drive of FIG. 7 locked in a counterclockwise position, according to an embodiment of the present general inventive concept.

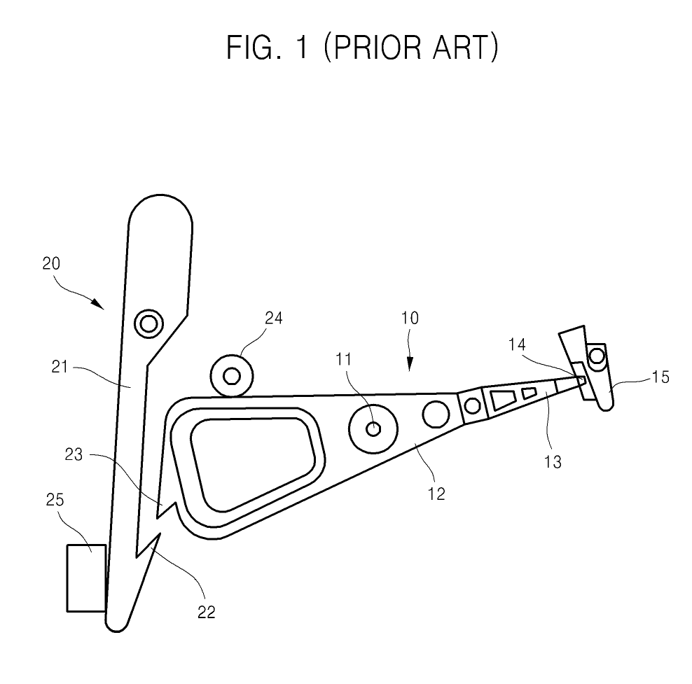

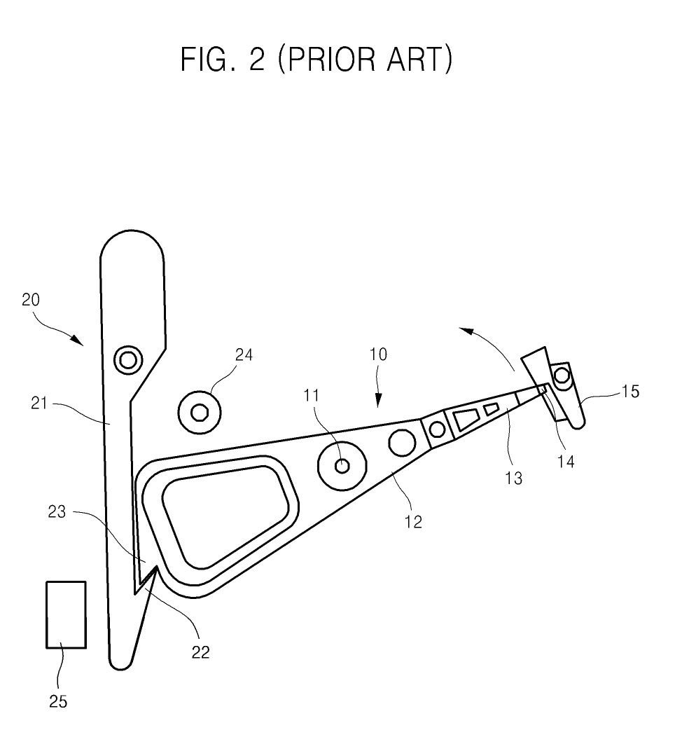

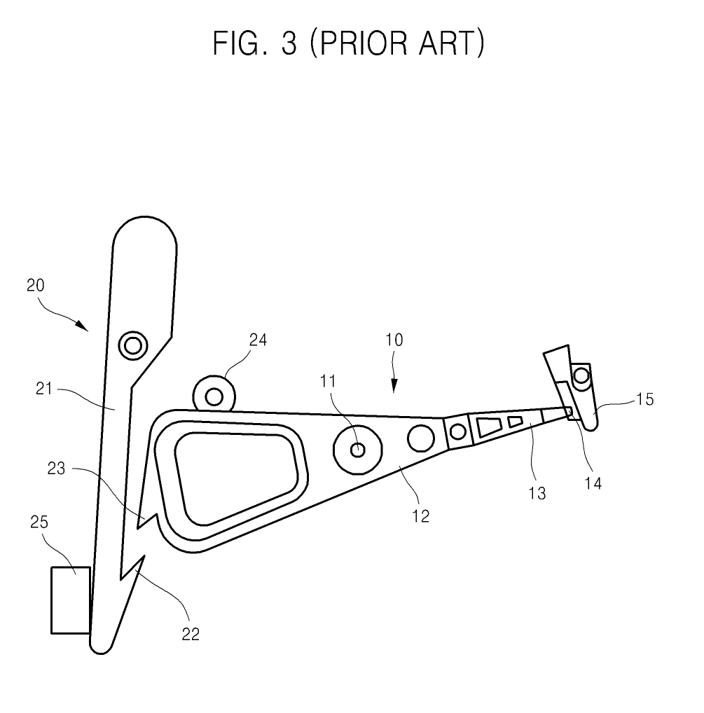

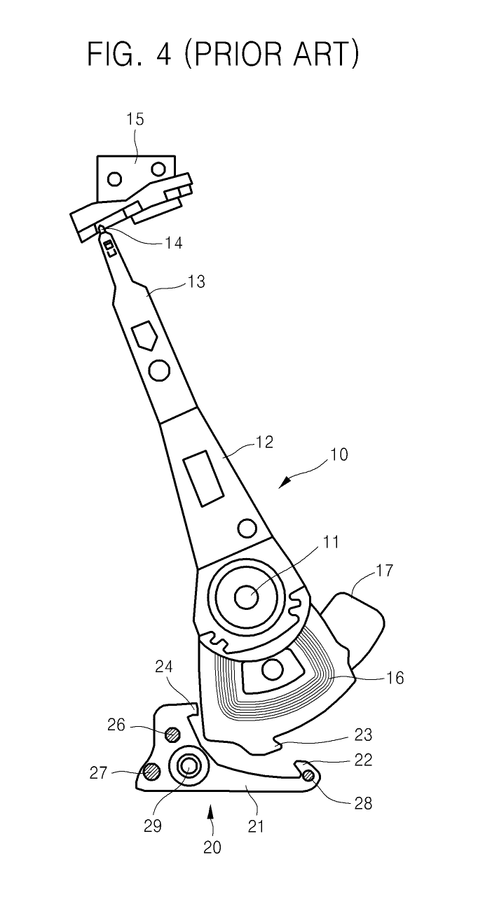

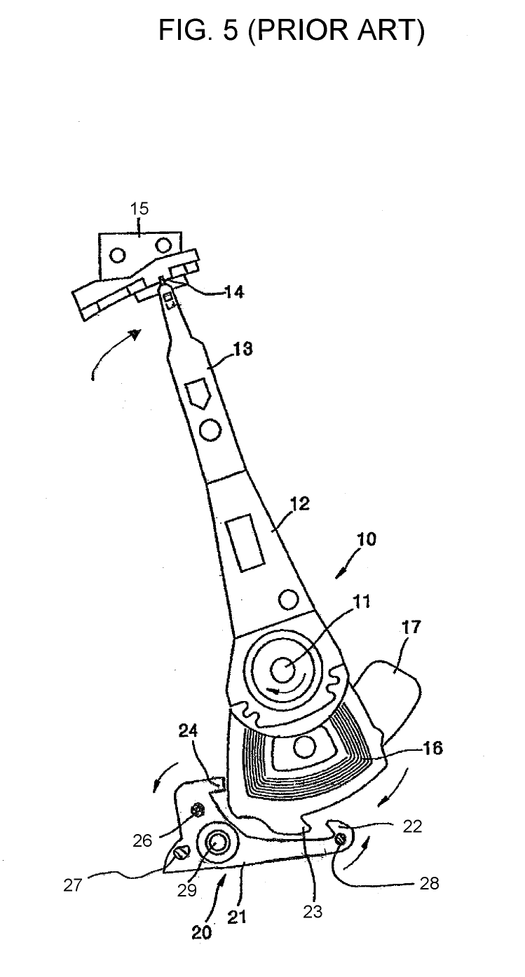

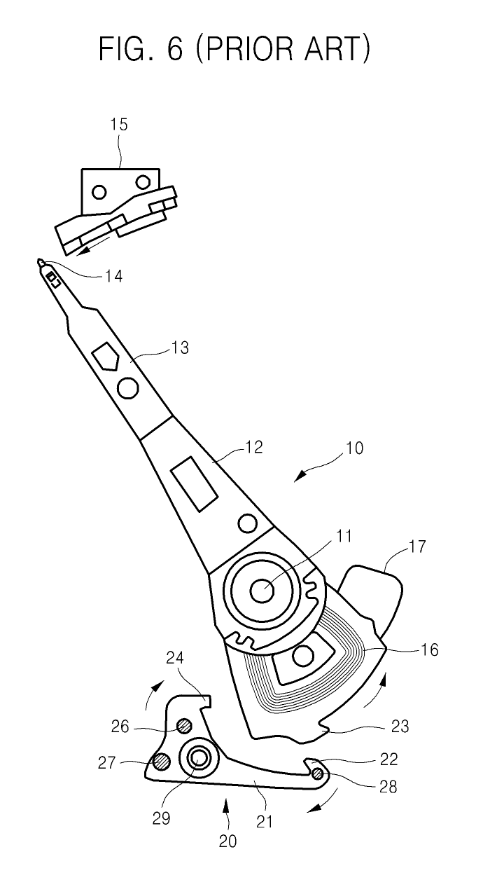

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

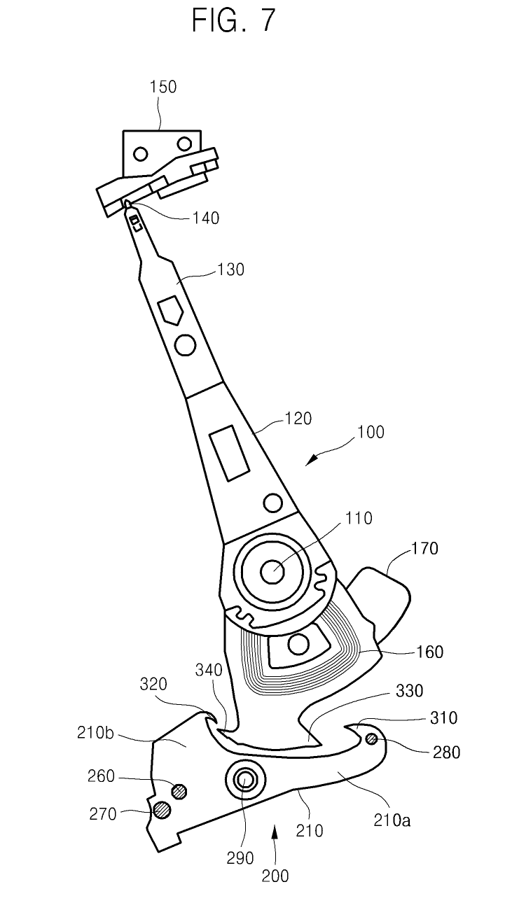

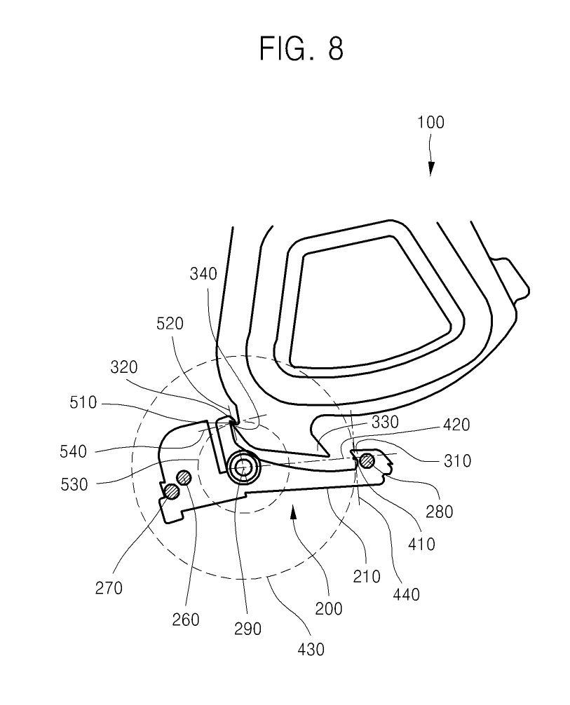

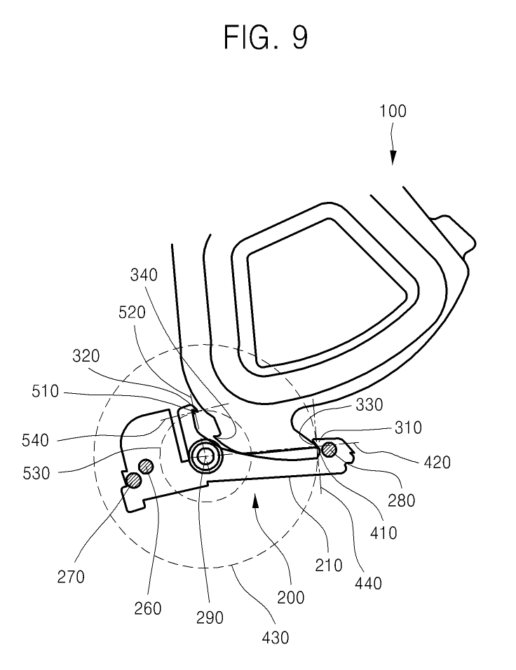

FIG. 7 is a view illustrating a hard disk drive (HDD), according to an embodiment of the present general inventive concept. FIG. 8 is a view illustrating an actuator 100 of the hard disk drive of FIG. 7 locked in a clockwise position, according to an embodiment of the present general inventive concept. FIG. 9 is a view illustrating the actuator 100 of the hard disk drive of FIG. 7 locked in a counterclockwise position, according to an embodiment of the present general inventive concept.

Referring to FIG. 7, the hard disk drive according to the present embodiment includes the actuator (actuator arm) 100 and a latch lever 200. The actuator 100 includes a swing arm 120 to pivot around a pivot axis 110 to move a read/write head 140 towards and away from a desired position on a disk (not illustrated) of the hard disk drive. Furthermore, the actuator 100 includes a suspension 130 installed at a front end of the swing arm 120 near the read/write head 140 to support the read/write head 140 and to elastically bias the read/write head 140 towards a surface of the disk. The actuator 100 may also include a voice coil motor (VCM) to rotate the swing arm 120. The VCM may include a coil 160 coupled to a back end of the swing arm 120 and a magnet 170 facing the coil 160.

The latch lever 200 includes a latch arm 210 to rotate around a rotation axis 290. The latch arm 210 may include a first arm 210a extending from the rotation axis 290 and a second arm 210b extending from the rotation axis 290 in a direction substantially perpendicular to the first arm 210a. An iron pin 260 may be installed on the latch arm 210 such that a magnetic force acts between the iron pin 260 and the magnet 170 to rotate the latch arm 210. The latch lever 200 may also include one or more balancing weights, such as balancing weights 270 and 280 illustrated in FIG. 7.

The hard disk drive of the present embodiment further includes an actuator locking system to lock the actuator 100 in the clockwise position and the counterclockwise position in response to a shock applied to the hard disk drive. The actuator locking system may include a first locking unit (described below) to lock the actuator 100 in the counterclockwise position and a second locking unit (described below) to lock the actuator 100 in the clockwise position. The first locking unit may include a first contact protrusion 330 disposed on a leading portion of the back end of the swing arm 120 and a first stop portion 310 disposed on a leading end of the first arm 210a to contact ant stop the first contact protrusion 330. The second locking unit may include a second contact protrusion 340 disposed on an end of the second arm 210b and a second stop portion 320 disposed on a rear portion of the latch lever 210 to contact and stop the second contact protrusion 340.

Referring to FIG. 7, when the read/write head 140 is parked in a park position on a ramp 150 of the hard disk drive, the read/write head 140 may be moved from the ramp 150 to a region above the surface of the disk (not illustrated) of the hard disk drive. For example, the VCM may cause the swing arm 120 to pivot in the counterclockwise direction around the pivot axis 110. At the same time, the latch arm 210 rotates in the clockwise direction around the rotation axis 290 due to the magnetic force acting between the magnet 170 and the iron pin 260. Accordingly, since the first contact protrusion 330 of the swing arm 120 is not interfered with by the first stop portion 310 of the latch arm 210, the swing arm 120 pivots in the counterclockwise direction without interference by the latch arm 210. Thus, the read/write head 140 may perform recording and/or reproducing operations to and/or from the disk (not illustrated).

In addition, the read/write head 140 may be moved from the disk to park on the ramp 150. For example, the VCM may cause the swing arm 120 to pivot in a clockwise direction around the pivot axis 110. As illustrated in FIG. 8, the second contact protrusion 340 contacts the second stop portion 320 at a second contact point 510. The second stop portion 320 locks with the second contact protrusion 340, thus parking the read/write head 140 on the ramp 150 and preventing the swing arm 120 of the actuator 100 from further pivoting in the clockwise direction.

When the read/write head 140 is parked on the ramp 150 and a clockwise rotational shock is applied to the hard disk drive of the present embodiment, the swing arm 120 of the actuator 100 and the latch arm 210 each pivot in a counterclockwise direction. As illustrated in FIG. 9, the first contact protrusion 330 contacts the first stop portion 310 at a first contact point 410. The first stop portion 310 locks with the first contact protrusion 330, thus preventing the swing arm 120 of the actuator 110 from further pivoting in the counterclockwise direction.

On the other hand, when the read/write head 140 is parked on the ramp 150 and a counterclockwise rotational shock is applied to the hard disk drive of the present embodiment, the swing arm 120 of the actuator 100 and the latch arm 210 each pivot in a clockwise direction. As illustrated in FIG. 8, the second stop protrusion 340 contacts the second stop portion 320 at the second contact point 510. In this way, the second stop portion 320 may act as a crash stop, i.e., may serve in place of a crash stop. In particular, the second stop portion 320 locks with the second contact protrusion 340, as opposed to acting as only a rebounding surface, thus preventing the swing arm 120 of the actuator 100 from further pivoting in the clockwise direction.

Thus, in contrast to conventional hard disk drives, the swing arm 120 of the present embodiment does not rebound from (i.e., bounce off of) a crash stop operation when the swing arm 120 pivots in the clockwise direction. Instead, as discussed above, the second stop portion 320 locks with the second contact protrusion 340, which prevents the swing arm 120 from rebounding off of the second receiving part 320 of the latch arm 210. Accordingly, the contact of the second contact protrusion 340 with the second stop portion 320 (i.e., at the second contact point 510) does not transfer a momentum of the pivoting swing arm 120 to the latch lever 200. Thus, the locking of the second contact protrusion 340 with the second stop portion 320 prevents the latch arm 210 from further rotating in the counterclockwise direction. As a result, a timing of the pivoting of the swing arm 120 in the counterclockwise direction matches a timing of the rotation of the latch arm 210 in the counterclockwise direction, thus properly aligning the first receiving part 310 and the first protrusion 330. In particular, the first stop portion 310 and the first contact protrusion 330 are properly aligned such that when the second stop portion 320 separates from the second contact protrusion 340, the first stop portion 310 will then align and lock with the first contact protrusion 330 in the counterclockwise rotated position. Accordingly, the proper alignment of the first stop portion 310 and the first contact protrusion 330 resulting from the locking of the second contact protrusion 340 with the second stop portion 320 allows a consistent locking of the swing arm 120 in the clockwise and counterclockwise positions to prevent the swing arm 120 from damaging the disk.

More specifically, the second stop portion 320 of the latch arm 210 contacts the second contact protrusion 340 of the actuator at the second contact point 510 with a force extending in a radial direction away from the rotation axis 290 of the latch arm 210 such that no rotational momentum is created by the contact between the second stop portion 320 and the second contact protrusion 340. When the second contact protrusion 340 separates from the second stop portion 320, the first stop portion 310 contacts the first contact protrusion 330 at the first contact point 410 with a force extending in a second radial direction extending away from the rotation axis 290 such that no rotational momentum is created by the contact between the first stop portion 310 and the first contact protrusion 330. Moreover, the forces created at the first and second contact points 410 and 510 may be perpendicular to a normal line of the respective concentric circles with respect to the rotation axis 290 of the latch arm 210.

As illustrated in FIGS. 7-9, the first and second stop portion 310 and 320 may be hook shaped while the first and second contact protrusions 330 and 340 may be notch shaped to be locked by the first and second stop portions 310 and 320, respectively. However, the first and second stop portions 310 and 320 are not limited to being hook shaped and the first and second contact protrusions 330 and 340 are not limited to being notch shaped. For example, the first and second stop portions 310 and 320 may each be female parts and the first and second contact protrusions 330 and 340 may be male parts. In other words, the hook shaped portions and the notch portions can be alternatively disposed with respect to the latch arm 210 and the swing arm 120. Accordingly, shapes and structures of the first and second stop portions 310 and 320 and the first and second contact protrusions 330 and 340 may vary as long as the shapes and structures are sufficient to lock the swing arm 120 in the clockwise and counterclockwise positions.

Furthermore, as illustrated in FIGS. 7-9, the first and second stop portions 310 and 320 may face the first and second contact protrusions 330 and 340, respectively. For example, the first and second contact protrusions 330 and 340 may extend away from each other, and the first and second stop portions 310 and 320 may face each other. Alternatively, the first and second stop portions 310 and 320 may each face a first direction, and the first and second contact protrusions 330 and 340 may face the first and second stop portions 310 and 330, respectively, i.e., the first and second contact protrusions 330 and 340 may each face a second direction opposite to the first direction. In addition, the first stop portion 310 may be disposed on a first part of the latch arm 210/210a, extending from the rotation axis 290 in a first direction, and the second stop portion 320 may be disposed on a second part of the latch arm 210/210b, extending from the rotation axis 290 in a second direction substantially perpendicular to the first direction. For example, as illustrated in FIGS. 7-9, the first stop portion 310 may be disposed on the leading portion of the latch arm 210a and the second stop portion 320 may be disposed on the rear portion of the latch arm 210b. Accordingly, locations and orientations of the first and second stop portions 310 and 320 and the first and second contact protrusions 330 and 340 may vary as long as the locations and orientations are sufficient to lock the swing arm 120 in the clockwise and counterclockwise positions.

As illustrated in FIGS. 8 and 9, the rotation axis 290 of the latch lever 200 may be a center of first and second virtual circles 430 and 530. In the present embodiment, the first and second stop portions 310 and 320 may be spaced apart from each other on the latch lever 200 by a predetermined distance. The predetermined distance may be a distance such that the contact point 410 where the first stop portion 310 contacts the first contact protrusion 330 is on a first normal line 420 of the first virtual circle 430 (i.e., normal to tangent line 440), and the contact point 510 where the second stop portion 320 contacts the second contact protrusion 340 is on a second normal line 520 of the second virtual circle 530 (i.e., normal to tangent line 540). A diameter of the first virtual circle 430 may be different from a diameter of the second virtual circle 430 based on the predetermined distance between the first and second stop portions 310 and 320, as illustrated in FIGS. 8 and 9. For example, as illustrated in FIGS. 8 and 9, the diameter of the first virtual circle 430 may be larger than the diameter of the second virtual circle 530.

A method of operating the actuator 100 during a normal operation thereof, according to an embodiment of the present general inventive concept, will now be described with reference to FIGS. 7-9.

Referring to FIG. 7, when the read/write head 140 is parked on a ramp 150 of the hard disk drive, the read/write head 140 may be moved from the ramp 150 to an area above the surface of the disk (not illustrated) of the hard disk drive to reproduce and/or record data from and/or to the disk. Specifically, the swing arm 120 is pivoted around the pivot axis 110 in the counterclockwise direction to move the read/write head 140 from the ramp 150 to the surface of the disk. For example, the VCM may be used to pivot the swing arm 120 in the counterclockwise direction. At the same time, the latch arm 210 is rotated around the rotation axis 290 in the clockwise direction. For example, the latch arm 210 may be rotated in the clockwise using the magnetic force acting between the magnet 170 and the iron pin 260. Due to the rotation of the latch arm 210, the first stop portion 310 of the latch arm 210 is prevented from interfering with the first contact protrusion 330 of the swing arm 120, and the swing arm 120 is pivoted in the counterclockwise direction without interference by the latch arm 210.

Referring to FIGS. 7 and 8, after the read/write head 140 reproduces and/or records data from and/or to the disk, the swing arm 120 is pivoted around the pivot axis 110 in the clockwise direction to move the read/write head 140 from an area above the surface of the disk to the ramp 150 to park the read/write head 140 on the ramp 150. For example, the VCM may be used to pivot the swing arm 120 in the clockwise direction. As illustrated in FIG. 8, the actuator 100 is then locked in the clockwise position, with the read/write head 140 parked on the ramp 150, to prevent the swing arm 120 of the actuator 110 from further pivoting in the clockwise direction. For example, the second contact protrusion 340 come into contact with the second stop portion 320 at the second contact point 510 to lock the actuator 100 in the clockwise position.

A method of locking the actuator 100 in clockwise and counter clockwise positions in response to a rotary shock, according to an embodiment of the present general inventive concept, will now be described with reference to FIGS. 7-9.

Referring to FIGS. 7 and 9, when the read/write head 140 is parked on the ramp 150 and a clockwise rotational shock is applied to the hard disk drive of the present embodiment, the swing arm 120 is pivoted around the pivot axis 110 in the counterclockwise direction and the latch arm 210 is rotated around the rotation axis 290 in the counterclockwise direction. As illustrated in FIG. 9, the actuator 100 is then locked in the counterclockwise position to prevent the swing arm 120 from further pivoting in the counterclockwise direction and damaging the surface of the disk. For example, the first contact protrusion 330 may come into contact with the first stop portion 310 at the first contact point 410 to lock the actuator 110 in the counterclockwise position.

On the other hand, referring to FIGS. 7 and 8, when the read/write head 140 is parked on the ramp 150 and a counterclockwise rotational shock is applied to the hard disk drive of the present embodiment, the swing arm 120 is pivoted around the pivot axis 110 in the clockwise direction and the latch arm 210 is rotated around the rotation axis 290 in the clockwise direction. As illustrated in FIG. 8, the actuator 100 is then locked in the clockwise position to prevent the swing arm 120 from further pivoting in the clockwise direction and to prevent a transfer of momentum of the pivoting swing arm 120 to the latch arm 210. For example, the second contact protrusion 340 may come into contact with the second stop portion 320 at the second contact point 510 to lock the actuator 110 in the clockwise position.

As described above, an actuator locking system according to various embodiments of the present general inventive concept can lock the actuator in clockwise and counterclockwise positions, thus ensuring a desired locking of the actuator during a variety of conditions, including normal operating conditions, after a clockwise rotary shock, and after a counterclockwise rotary shock. Because a point of contact between protrusions and receiving parts of the system are on normal lines of concentric virtual circles, the points of contact reduce and/or eliminate a momentum of the actuator to limit unwanted movement thereof, for example, resulting from a contact between the actuator and a latch lever. Thus, a rebounding timing mismatch between the actuator and the latch lever can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A HDD assembly, comprising:
an actuator arm including first and second contact protrusions extending from a rear portion thereof; and
a latch lever including a rotation axis at which the latch lever rotates and first and second stop portions disposed at predetermined locations on the latch lever to engage with respective ones of the first and second contact protrusions of the actuator arm, the first stop portion acting as a crash stop for the actuator arm,
wherein the first stop portion contacts the respective first contact protrusion to act as the crash stop with a force in a direction extending directly outward along a radial direction of the rotation axis of the latch lever such that no rotational momentum is created by the contact between the first stop portion and the first contact protrusion.

2. The HDD of claim 1, wherein the first and second stop portions are hook shaped and the first and second contact protrusions are notch shaped.

3. The HDD of claim 2, wherein after the contact between the first hook portion and the first contact protrusion, the second hook portion contacts the respective second contact protrusion with a force in a direction extending directly outward along a second radial direction of the rotation axis of the latch lever such that no rotational momentum is created by the contact between the second hook portion and the second contact protrusion.

4. A disc operating device to read and/or write to and/or from a storage disc, comprising:
an actuator including:
a head portion to read and/or write to and/or from the storage disc, and
first and second notches extending from a rear portion of the actuator; and
a latch member to lock the actuator in a park position when not reading or writing to or from the disc, the latch member including:
a rotation axis at which the latch member rotates, and
first and second hook portions to contact respective ones of the first and second notches at corresponding first and second contact points of the latch member such that forces created at the first and second contact points are perpendicular to a normal line of a respective concentric circle with respect to the rotation axis of the latch member.

5. The disc operating device of claim 4, wherein the latch member comprises a first arm extending from the rotation axis and a second arm extending from the rotation axis in a direction substantially perpendicular to the first arm, the first hook portion being disposed at an end of the first arm opposite to the rotation axis and the second hook portion being disposed at an end of the second arm opposite to the rotation axis.

6. The disc operating device of claim 4, wherein the first hook portion is disposed at a location to act as a crash stop for the actuator when the actuator is rotating into a park position and the second hook portion is disposed at a location to act as a rebound stopper to stop the movement of the actuator after the actuator rebounds from the crash stop location.

7. A method of parking an actuator of a disc drive assembly, the method comprising:
rotating the actuator in a first direction towards a parking position; and
creating a first contact between a first notch extending from a rear portion of the actuator and a first stopping member of a rotatable latch lever when the actuator is rotated in the first direction such that a contact force on the rotatable latch lever caused by the first contact is in a direction extending radially outward from a rotation axis of the rotatable latch lever and perpendicular to a normal line of a first circle having a center located at the rotation axis of the rotatable latch lever.

8. The method of claim 7, further comprising:
creating a second contact between a second notch extending from the rear portion of the actuator and a second stopping member of the rotatable latch lever when the actuator is rotated in a second direction after the contact between the first notch and the first stopping member such that a second contact force on the rotatable latch lever caused by the second contact is in a direction extending radially outward from the rotation axis of the rotatable latch lever and perpendicular to a normal line of a second circle being concentric with the first circle.

9. A parking unit to park an actuator arm of a disc drive assembly, comprising:
a rotation axis on which the parking unit rotates; and
at least one extension member extending away from the rotation axis and having a stopping portion which contacts a protrusion of the actuator arm to stop the actuator arm from rotating in a direction towards the park position, the stopping portion being positioned such that when the protrusion contacts the stopping portion a force is created on the at least one extension member in a direction along a length of the at least one extension member such that no rotation momentum is created on the parking unit.

10. The parking unit of claim 9, wherein the at least one extension member comprises first and second extension members, and wherein the first extension member contacts a first protrusion of the actuator arm to stop the actuator arm from rotating in a direction towards the park position and the second extension member contacts a second protrusion of the actuator arm to stop the actuator arm from rotating in a direction opposite to the direction of rotation towards the park position due to a rebound force created by the contact between the first protrusion and the first extension member such that the actuator becomes locked between the first extension member and the second extension member while the actuator arm is parked.

11. A hard disk drive assembly, comprising:
an actuator including a pivot axis around which the actuator pivots, and a read/write head to record and/or reproduce data on a disk of the hard disk drive assembly;
a latch lever including a rotation axis around which the latch lever rotates; and
an actuator locking system extending from a portion of the actuator and the latch lever to lock the actuator in a clockwise position in response to a counterclockwise rotary shock applied to the hard disk drive, and to lock the actuator in a counterclockwise position in response to a clockwise rotary shock applied to the hard disk drive.

12. The hard disk drive of claim 11, wherein the actuator locking system comprises:
a first locking unit on one of the actuator and the latch lever to lock the actuator in the counterclockwise position; and
a second locking unit on the other one of the actuator and the latch lever to lock the actuator in the clockwise position.

13. The hard disk drive of claim 12, wherein:
the first locking unit comprises a first contact protrusion disposed on an end of the actuator facing the latch lever and a first stop portion disposed on the latch lever to contact the first contact protrusion to lock the actuator in the counterclockwise position; and
the second locking unit comprises a second contact protrusion disposed on the end of the actuator facing the latch lever and a second stop portion disposed on the latch lever to contact the second contact protrusion to lock the actuator in the clockwise position.

14. The hard disk drive of claim 13, wherein:
the first and second contact protrusions are first and second notches; and
the first and second stop portions are first and second latches.

15. The hard disk drive of claim 13, wherein the first and second stop portions face the first and second contact protrusions, respectively.

16. The hard disk drive of claim 13, wherein the first and second contact protrusions extend away from each other.

17. The hard disk drive of claim 13, wherein the first and second stop portions face each other.

18. The hard disk drive of claim 13, wherein the first and second stop portions are disposed a predetermined distance from each other on the latch lever such that a point on the latch lever where the first contact protrusion and the first stop portion contact each other is on a normal line of a first virtual circle having a center at the rotation axis of the latch lever and a point on the latch lever where the second contact protrusion and the second stop portion contact each other is on a normal line of a second virtual circle having a center at the rotation axis of the latch lever.

19. The hard disk drive of claim 18, wherein a diameter of the first virtual circle is greater than a diameter of the second virtual circle.

20. The hard disk drive of claim 13, wherein when the swing arm rotates in a clockwise direction and collides with the latch lever, the second stop portion contacts the second contact protrusion to lock the actuator in the clockwise position and to prevent the collision from further rotating the latch lever in a counterclockwise direction.

21. An actuator locking system of a hard disk drive, comprising:
a first locking unit comprising a first contact protrusion disposed on an actuator of the hard disk drive and a first stop portion disposed on a latch lever of the hard disk drive to contact the first contact protrusion to lock the actuator in a counterclockwise position; and
a second locking unit comprising a second contact protrusion disposed on the actuator and a second stop portion disposed on the latch lever to contact the second contact protrusion to lock the actuator in a clockwise position.

22. A latch lever of a hard disk drive, comprising:
a first stop portion to contact a first portion of an actuator of the hard disk drive to lock the actuator in a counterclockwise position; and
a second stop portion to contact a second portion of the actuator to lock the actuator in a clockwise position,
wherein the first and second stop portions are disposed a predetermined distance from each other on the latch lever such that a point of contact on the latch lever between the first contact protrusion and the first stop portion is on a normal line of a first virtual circle having a center at a rotation axis of the latch lever, and a point of contact on the latch lever between the second contact protrusion and the second stop portion is on a normal line of a second virtual circle having a center at the rotation axis of the latch lever.

23. A method of locking an actuator of a hard disk drive, the method comprising:
rotating the actuator in a first rotation direction to contact a first protrusion of the actuator with a first stop portion of a latch lever to lock the actuator at a first position; and
rotating the actuator in a second rotation direction opposite to the first rotation direction to contact a second protrusion of the actuator with a second stop portion of the latch lever to lock the actuator at a second position different from the first position.

24. The method of claim 23, wherein:
the rotating of the actuator in the first rotation direction comprises contacting the first protrusion with the first stop portion at a point on the latch lever that is on a normal line of a first virtual circle having a center at a rotation axis of the latch lever; and
the rotating of the actuator in the second rotation direction comprises contacting the second protrusion with the second stop portion at a point on the latch lever that is on a normal line of a second virtual circle having a center at the rotation axis of the latch lever.
